(19) United States
(12) Patent Application Publication
(10) Pub. No.: US 2003/0033314 A1
(43) Pub. Date: Feb. 13, 2003

(54) Efficient method to describe hierarchical data structures

(76) Inventor: Hans-Joachim Muschenborn, Walchwil (CH)

Correspondence Address: DR. HANS-GOACHIM MUSCHENBORN, BUNDESSTR. 7, CH-6304 ZUG, SWITZERLAND, CH-6304, CH

(21) Appl. No.: 10/161,748

(22) Filed: Jun. 5, 2002

(30) Foreign Application Priority Data
Jun. 18, 2001 (DE) 10129286.4

(51) Int. Cl. G06F 7/00

(52) U.S. Cl. 707/100

(57) ABSTRACT

The present invention—called Efficient Description Language EDL—concerns methods to describe, parsers and generators of as well as systems storing, processing, transmitting or using arbitrary hierarchical data structures in a platform independent format and overcomes the prior art limitations using only a single starting respectively terminating character to introduce respectively terminate individual branches and data elements.

Branches may contain any number of sub-branches and data elements in any order. The maximum nesting level of sub-branches is not limited.

Branches and/or data elements may be anonymous or named and associated with a named type, multiple named attributes, default values or value range restrictions.

EDL-documents may reference other EDL-documents to include them in the referencing document. Referenced documents may contain references to other EDL-documents, as long as no circular reference chain results.

EDL-documents may include control statements to efficiently describe conditional or repeating content.

EDL-documents are very easy to read, create and maintain by humans—even without extensive training—and can be generated, parsed and processed faster than platform independent documents in prior art languages.

To describe identical data structures with identical content EDL-documents require on average ˜50% less meta characters and ˜33% less storage capacity and communication bandwidth compared to HTML, XML or SGML-documents.

In total, EDL is more efficient than prior art platform independent languages and reduces the overall development, building, operation and maintenance costs of heterogenous distributed communication and information processing systems.

### CROSS-REFERENCES TO RELATED APPLICATIONS

This invention can be used in any information processing system according to the following related patent applications:

1. U.S. utility patent application Ser. No. 09/558,435 filed on Apr. 25, 2000 and

2. U.S. utility patent application Ser. No. 09/740,925 filed on Dec. 19, 2000.

### STATEMENT REGARDING FEDERALLY SPONSORED RESEARCH AND DEVELOPMENT

Not Applicable

### REFERENCES TO ADDITIONAL MATERIAL

An appendix giving examples of language grammars according to the present invention is included at the end of the specification.

### TECHNICAL FIELD

This invention concerns methods to describe arbitrary hierarchical data structures in a platform independent format, parsers and generators of platform independent descriptions of arbitrary hierarchical data structures, and systems storing, processing, transmitting or using platform independent descriptions of arbitrary hierarchical data structures. Different possible grammars are given in the appendix of this patent.

### BACKGROUND OF THIS INVENTION

In prior art heterogenous networks, like the Internet, data trees are described in platform independent plain text languages. Typical representatives of these languages are the Standard Generalized Markup Language SGML as well as the Hypertext Markup Language HTML, the Extensible Hypertext Markup Language XHTML, and the Extensible Markup Language XML, all derived from SGML. These languages allow to exchange arbitrary data between processing units running different operating systems, as long as the units have the capability to correctly interpret data descriptions given in a specific language and translate them into local—platform dependent—data. Common Internet-browser, like Netscape Communicator, Microsofts Internet Explorer, Opera, and others are capable to interpret HTML and XML.

Prior art platform independent data description languages have the following disadvantages:

1. The ratio between syntactical meta characters and net data content is relatively low, i.e. the syntax and semantics of prior art data description languages require a huge amount of meta data compared to a small effective net data content, resulting in a significant increase of the data volume.

2. The increased data volume increases immediately the requirements on storage capacity, CPU-performance and communication bandwidths. Since platform independent languages are designed for the data exchange in heterogenous networks, languages with a low meta/net data ratio significantly increase the data volume to be transported with immediate negative consequences with regards to network capacity, network performance, over all system response time, etc. To handle the meta data overhead, in many cases additional hardware has to be installed at very high costs for the required infrastructure (buildings, rooms, energy and security installation), purchase, administration and maintenance. Hardware manufactures even push such inefficient software technology to boost their hardware sales.

3. Redundant meta tags, repeated at the begin and end of a branch increase the syntactical error possibilities.

4. Missing reference possibilities increase redundant data repetitions and limit the description to tree like organized data structures.

5. The definitions of prior art languages—especially of extendable languages like XML with separate DTD's—are so wide and complex, that a correct interpretation requires a large amount of CPU-time and reduces the response time of the system dramatically. Prior art platform independent data description languages significantly deteriorate the overall system performance, especially in applications with huge data transfer volumes, like transaction oriented web servers with a large number of clients, or the exchange of large data streams, like the update of data bases via networks.

6. In many cases—especially related to the Internet—data content is entered manually—like HTML-files. The huge proportion of meta data in prior art platform independent data description languages requires first, a detailed knowledge of the syntax and grammar of the particular language and second, a large amount of cost intensive manual work to reach a syntactically correct description of the desired content.

### OBJECT OF THIS INVENTION

The object of this invention is to efficiently describe arbitrary hierarchical data structures in a platform independent format, which can be generated, stored and exchanged in arbitrary information processing systems—especially heterogenous networks—as easy, fast and cost effective as possible.

### SUMMARY OF THIS INVENTION

The present invention overcomes the prior art limitations by efficient methods—called Efficient Description Language EDL—to describe arbitrary hierarchical data structures in platform independent formats using only a single starting resp. terminating character to introduce resp. terminate branches and data elements.

Branches may contain any number of sub-branches and data elements, which can be specified in any order. The maximum nesting level of sub-branches is not limited.

Branches and/or data elements may be anonymous or named and associated with a named type, an arbitrary number of named attributes, default values and/or value range restrictions.

EDL-documents may reference other EDL-documents to include them in the referencing document. Referenced documents may contain themselves further references to other EDL-documents, as long as no circular reference chain results.

EDL-documents may include control statements—comparable to modern programming languages—to efficiently describe conditional or repeating content.

EDL-documents are very easy to read, create and maintain by humans—even without extensive training—and can be generated, parsed and processed faster than platform independent documents in prior art languages.

To describe identical data structures with identical content EDL-documents require on average ˜50% less meta characters and ˜33% less storage capacity and communication bandwidth compared to HTML, XML or SGML-documents.

In total, EDL is more efficient than prior art platform independent languages and reduces the overall development, building, operation and maintenance costs of heterogenous distributed communication and information processing systems.

### BRIEF DESCRIPTION OF FIGURES

FIG. 1: illustrates a simple hierarchical data structure with a single branch and several data elements, where all elements are a) anonymous and b) named.

FIG. 2: illustrates an hierarchical data structure with nested sub-branches (i.e. a sub-branch containing another sub-branch), where in part a) all branches and data elements are anonymous and in part b) named as well as anonymous.

### DETAILED DESCRIPTION OF THIS INVENTION

The present invention overcomes the prior art limitations by an efficient method to describe arbitrary hierarchical data structures according to claim 1—throughout this patent also called “Efficient description language” or “EDL”—, where each branch may contain an arbitrary number (inclusive 0) of data elements and an arbitrary number (inclusive 0) of dependent branches—also called “sub-branches” —, and whereby each branch and each data element is introduced by a single character SB respectively SD of a given alphabet A and terminated by a single character TB respectively TD of said alphabet A.

The initial and terminal characters SB, SD respectively TB and TD in a method to describe arbitrary hierarchical data structures according to claim 1 do not have to be necessarily unique. Instead they can be freely chosen from alphabet A, as long as the syntax of the underlying language, the context and the syntactical position of the character within a given data description uniquely identifies its meaning. To simplify the parser it is advantageous to select four different characters SB, SD, TB and TD. This also enables the parser to quickly and uniquely check the syntactical validity of a given data description according to claim 1.

The underlying alphabet can be chosen arbitrarily. Typical examples are any national or international character set, like ASCII, Unicode or others. The alphabet is not limited to writable characters only, instead it can be coded also in binary or according to any other convention. Also the length of a character of the alphabet is not limited to any fixed number of bits, instead individual characters could be coded using only a single bit/byte, while other characters of the same alphabet consist of multiple bits/bytes. The most efficient alphabet to parse is certainly an alphabet, which comprises only single byte characters—like the ASCII character set—. In this case, binary data content has to be specially encoded to avoid ambiguities between meta data and data content. A typical example is the coding of an arbitrary binary value by a sequence of hexadecimal digits, where each digit is represented by the characters ‘0’,-‘9’, ‘A’,-‘F’, ‘a’,-‘f’ and where each character represents four bits out of a value range from ‘0000’ to ‘1111’. This example leaves enough possibilities for the choices of the syntactical control characters SB, SD, TB and TD.

The representation of standard data types, like strings, booleans, integers, floating point numbers, data etc. can be formatted arbitrarily—in particular as binary numbers or character strings—. String representations have the disadvantage to consume more storage space, but the advantage of better human readability. Binary representations are more efficient regarding storage consumption and parser effort, but have to be converted into a binary data format of the particular processing unit, otherwise the interpretation of the data would not be platform independent. For better human readability all examples in this patent are given in string representation. Nevertheless, the author emphasizes that claim 1 allows an arbitrary coding of the underlying alphabet and the described data content, as long as the syntactical control characters SB, SD, TB and TD can be uniquely determined by the parser.

Special embodiments of an efficient method to describe arbitrary hierarchical data structures according to claim 1 are given in the following examples, which all are based on the sample syntax rules summarized in the appendix.

### EXAMPLE 1

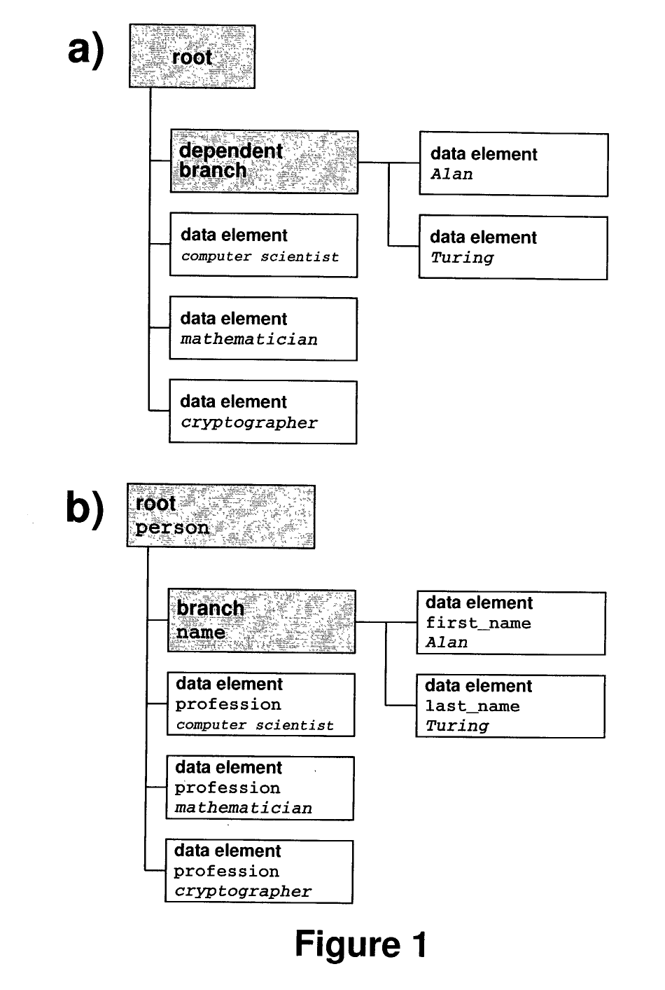

EDL-document according to claim 1 to describe the hierarchical data structure shown in FIG. 1a.

| | |
|---|---|
| { | # start of root branch |

| | |
|---|---|
| { | # start of sub branch |

| | |
|---|---|
| ′Alan′ | # data element in sub-branch |
| ′Turing′ | # data element in sub-branch |

| | |
|---|---|
| } | # end of sub-branch |
| ′computer scientist′ | # data element in root branch |
| ′mathematician′ | # data element in root branch |
| ′cryptographer′ | # data element in root branch |

| | |
|---|---|
| } | # end of root branch |

Statistics:
Total:
68 characters (without empty space like SPACE, CR & TAB)
with:
14 meta characters (printed plain)
54 content (printed in italics)
ratio content/meta characters: 54/14 = 3.857

Example 1 describes the data structure shown in FIG. 1a using 14 meta characters versus a data content of 54 characters. This results in a total of 68 characters (not counting empty space) and a ratio content/meta characters of nearly 3.9. Additionally, the description is very well structured, easily readable even by persons without special computer skills and can be created and edited very efficiently.

### EXAMPLE 2

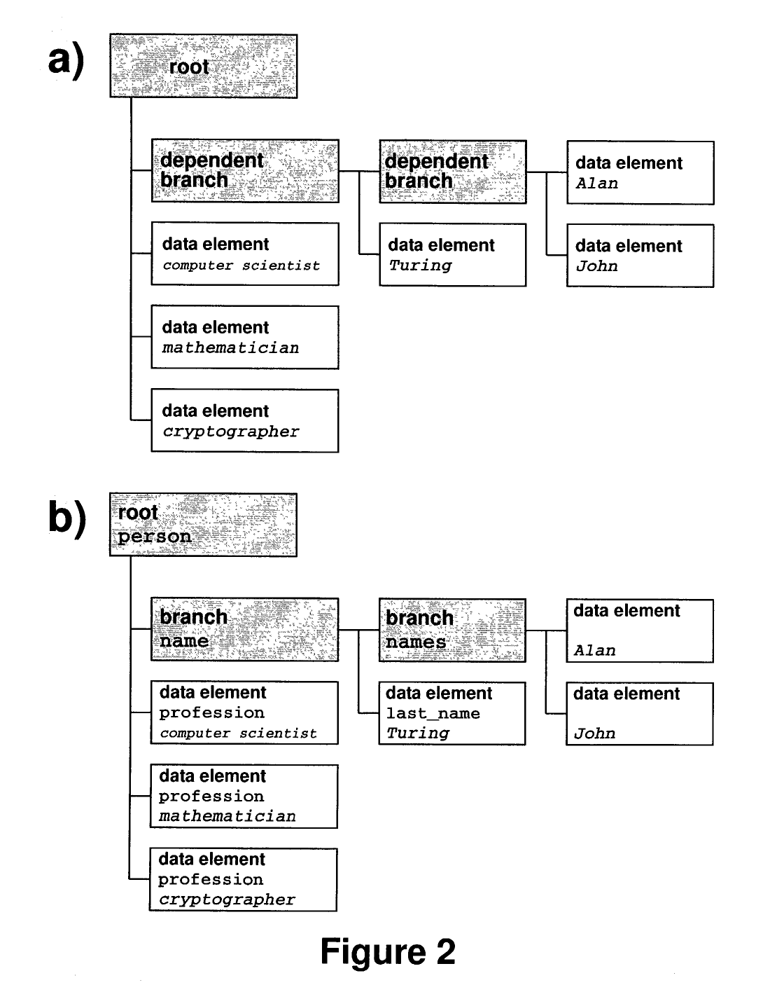

EDL-document according to claim 1 to describe the hierarchical data structure shown in FIG. 2a with three nested branch:

| { | | # start of root branch |
|---|---|---|
| | { | # start of sub-branch B1 |

| | |
|---|---|
| { | # start of sub-branch B1.B2 |

| | |
|---|---|
| ′Alan′ | # data element in branch B1.B2 |
| ′John′ | # data element in branch B1.B2 |

| | |
|---|---|
| } | # end of branch B1.B2 |
| ′Turing′ | # data element in branch B1 |

| | |
|---|---|
| } | # end of branch B1 |
| ′computer scientist′ | # data element in root branch |
| ′mathematician′ | # data element in root branch |
| ′cryptographer′ | # data element in root branch |

| | |
|---|---|
| } | # end of root branch |

Statistics:
Total:
76 characters (without empty space like SPACE, CR & TAB)
with:
18 meta characters (printed plain)
58 content (printed in italics)
ratio content/meta characters: 58/18 = 3.222

Example 2 illustrates, that sub-branches may contain own sub-branches and that sub-branches and data elements may be arranged in any order within the super-branch. The number of nested branch levels as well as the number of data elements and sub-branches within the root and any sub-branch are in principle not limited.

In Examples 1 and 2 the semantic interpretation of a particular data element depends on its relative position within the given EDL-document. Methods describing arbitrary hierarchical data structures according to claim 2 and 3 actually allow to associate a name NB respectively ND to a given branch respectively data element. This enables the parser to relate the described content to a known interpretation.

### EXAMPLE 3

EDL-document according to claim 4 to describe the hierarchical data structure shown in FIG. 1b with named branches and data elements. Of cause, branches or data elements may remain anonymous. Nevertheless, a unique human and automatic interpretation is facilitated if—like in the given example—all elements are named.

person {

name {

first_name ′Alan′
last_name ′Turing′

}
profession ′computer scientist′
profession ′mathematician′
profession ′cryptographer′

}
Statistics:
Total:
127 characters (without empty space like SPACE, CR & TAB)
with:
73 meta characters (printed plain)
54 content (printed in italics)
ratio content/meta characters: 54/73 = 0.7397

In Example 3 the complete data structure is described using 73 meta characters—where branch and data element names are counted as meta characters—compared to a data content of 54 characters. This results in a total of 127 characters (not counting empty space) and a ratio content/meta characters of nearly 0.74. The naming of the elements enables humans to easily interpret the description and still can be efficiently created and edited.

### EXAMPLE 4

The description of the same data structure shown in FIG. 1b produces in HTML/XML:

<person>

<name>

<first_name>Alan</first_name>
<last_name>Turing</last_name>

<name>
<profession>computer scientist</profession>
<profession>mathematician</profession>
<profession>cryptographer</profession>

</person>
Statistics:
Total:
207 characters (without empty space like SPACE, CR & TAB)
with:
153 meta characters (printed plain)
54 content (printed in italics)
ratio content/meta characters: 54/153 = 0.353

In Example 4 the complete data structure is described using 153 meta characters—where branch and data element names are counted as meta characters—compared to a data content of 54 characters. This results in a total of 207 characters (not counting empty space) and a ratio content to meta characters of nearly 0.35.

Comparing the two descriptions of Example 3 (EDL) and Example 4 (XML) reveals the following results:

| | | |
|---|---|---|
| ratio XML Total/EDL Total: | 207/127 = 1.63 | reduction: 38.6% |
| ratio XML Meta/EDL Meta: | 153/73 = 2.10 | reduction: 52.3% |
| ratio XML content/EDL content: | 54/54 = 1.00 | |
| ratio EDL content/meta characters | 0.740/0.353 = 2.1 | |
| to XML content/meta characters: | | |

The two following examples 5 and 6 compare EDL with XML descriptions of the data structure with three nested branches shown in FIG. 2b. The results of the comparison between EDL and XML are similar to the results of the comparison between examples 3 and 4.

### EXAMPLE 5

EDL-document according to claim 3 to describe the hierarchical data structure shown in FIG. 2b with named branches, named and anonymous data elements and three nested branch levels.

person {

name {

names { ′Alan′ ′John′ }
last_name ′Turing′

}
profession ′computer scientist′
profession ′mathematician′
profession ′cryptographer′

}
Statistics:
Total:
130 characters (without empty space like SPACE, CR & TAB)
with
72 meta characters (printed plain)
58 content (printed in italics)
ratio content/meta characters: 58/72 = 0.806

### EXAMPLE 6

XML-description of the same data structure as in Example 5:

<person>

<name>

<names><Alan/><John/></names>
<last_name>Turing</last_name>

</name>
<profession>computer scientist</profession>
<profession>mathematician</profession>
<profession>cryptographer</profession>

</person>
Statistics:
Total:
207 characters (without empty space like SPACE, CR & TAB)
with:
149 meta characters (printed plain)
58 content (printed in italics)
ratio content/meta characters: 58/149 = 0.389

Comparing the two descriptions of Example 5 (EDL) and Example 6 (XML) reveals the following results:

| | | |
|---|---|---|
| ratio XML Total/EDL Total: | 207/130 = 1.59 | reduction: 37.2% |
| ratio XML Meta/EDL Meta: | 149/72 = 2.07 | reduction: 51.7% |
| ratio XML content/EDL content: | 58/58 = 1.00 | |
| ratio EDL content/meta | 0.806/0.389 = 2.07 | |
| characters to XML | | |
| content/meta characters: | | |

In both cases—Example 3 vs. Example 4 and Example 5 vs. Example 6—EDL saves roughly 50% of the required meta data describing the identical data structure with identical content, resulting in a reduction of about 30% of the total data volume compared to XML. In addition, the given EDL examples have a content to meta data ratio better by about a factor of 2 versus XML. These results can be roughly extrapolated to descriptions of other data structures, because the higher efficiency of EDL is based mainly on

1. fewer syntactical meta characters—i.e. all meta characters without names—, reduced to about 50% compared to XML and

2. the complete avoidance of the redundant repetition of the name in the terminating token of a named branch or data element.

Both savings together result—for descriptions of identical data structures with identical content—in a net reduction of about 50% of the total meta data (i.e. syntactical meta data and element names) required by EDL versus required by XML.

The comparison of EDL with other prior art platform independent data description language—like HTML, XHTML, MathML or SGML—comes to similar results, because all are actually derived from SGML or XML.

Compared to prior art the platform independent data description language EDL has—with similar flexibility—a much simpler syntax with less syntactical pitfalls, such that a human editor or automatic parser/generator can read, create and check EDL-descriptions significantly faster. In addition EDL reduces the total data volume by about one third (33%), which in turn significantly reduces the required storage capacities, CPU-performance and communication bandwidths and taking all together the total system costs—especially of the required infrastructure as well as equipment, operation and maintenance costs—. In addition, the similarity of EDL to common programming languages—like C/C++ or Java—facilitates software developers to work with EDL-descriptions in their day to day business.

Methods to describe arbitrary hierarchical data structures according to claims 4 or 5 offer the additional possibility to associate a data type to a branch (claim 4) respectively a data element (claim 5). The type association can follow different syntactical rules (some possibilities are given in Example 7).

In general, EDL data type definitions follow the same syntactical rules as the declaration of the elements themselves. Therefore EDL-documents require only a single parser and not different parsers for the document and the type definitions—as in the case of XML, which requires a document parser and an additional relatively complex parser to parse the complicated Document Type Definitions (DTD's).

### EXAMPLE 7

Different possible syntax forms to declare a data element with name name, type String and content Alan.

| | |
|---|---|
| String name ′Alan′ | # type, name, content |
| name String ′Alan′ | # name, type, content |
| name ′Alan′ String | # name, content, type |
| String ′Alan′ name | # type, content, Name |
| ′Alan′ String name | # content, type, Name |
| ′Alan′ name String | # content, name, type |

or as special attribute named Type (see also examples 12 to 16)

| | |
|---|---|
| name Type=String ′Alan′ | # name, type, content |
| name ′Alan′ Type=String | # name, content, type |
| name [Type=String] ′Alan′ | # name, type, content |
| name ′Alan′ [Type=String] | # name, content, type |
| name [Type=′String′] ′Alan′ | # name, type, content |
| name ′Alan′ [Type=′String′] | # name, content, type |

### EXAMPLE 8

Declaration of a type named Name

a) type name, type content
Name {

first_name String
last_name String

}
b) type content, type name
{

first_name String
last_name String

}Name
c) type name, type content with default values
Name {

first_name String ′Alan′
last_name String ′Turing′

}
d) type content with default values, type name
{

first_name String ′Alan′
last_name String ′Turing′

} Name

Different possible syntactical forms to declare a branch with name name and type Name

e) name, type, content
name Name {

first_name ′Alan′
last_name ′Turing′

}
f) name, content, type
name {

first_name ′Alan′
last_name ′Turing′

} Name
g) content, name, type
{

first_name ′Alan′
last_name ′Turing′

} name Name
h) type, name, content
Name name {

first_name ′Alan′
last_name ′Turing′

}
i) type, content, name
Name {

first_name ′Alan′
last_name ′Turing′

} name
j) content, type, name
{

first_name ′Alan′
last_name ′Turing′

} Name name

Different syntactical possibilities to specify the type

| | |
|---|---|
| k) Name | # only name of type |
| l) Type = Name | # as attribute with name ′Type′ |
| m) Type = ′Name′ | # as attribute with name ′Type′ |
| n) [Type = Name] | # as attribute with name ′Type′ |
| o) [Type = ′Name′] | # as attribute with name ′Type′ |

The direct specification of the type name as string (8.k) requires the smallest number of meta characters (see also examples 8.e-8.j).

If the type declaration contains default values (like in examples 8.c and 8.d), data element or branch descriptions do not need to specify all contained sub-branches or data elements explicitly. Instead, the unspecified sub-branches or data elements in a typed data element or branch description are replaced by the default values specified in the declaration of the specified type (claims 11 to 13).

### EXAMPLE 9

Declaration of a branch type Name with default content and incomplete description of data structures with type Name and substitution of the default content specified in the type declaration:

# declaration of the type ′Name′with default data content
Name {

first_name String ′Alan′
last_name String ′Turing′

}
a) not specified data element ′last_name′
name Name {

first_name ′Bob′

}
# implicit content:

| | |
|---|---|
| # | name Name { |

| | |
|---|---|
| # | first_name ′Bob′ |
| # | last_name ′Turing′ |

| | |
|---|---|
| # | } |

b) empty branch of type ′Name′
name Name {
}
# implicit content:

| | |
|---|---|
| # | name Name { |

| | |
|---|---|
| # | first_name ′Alan′ |
| # | last_name ′Turing′ |

| | |
|---|---|
| # | } |

### EXAMPLE 10

Declaration of a branch type Name with sub-branch names, implicit declared type Names and default content, and incomplete description of data structures of type Name with implicit substitution of the default content specified in the type declaration:

# declaration of the type ′Name′ with sub-branch ′Names′
# and default data content
Name {

| | | |
|---|---|---|
| names | Names | { ′Alan′ ′Bob′ } |

last_name String ′Turing′

}
a) not specified branch ′Names′
name Name {

last_name ′Smith′

}
# implicit content:
#

| | |
|---|---|
| # | name Name { |

| | | |
|---|---|---|
| # | names | { ′Alan′ ′Bob′ } |

| | |
|---|---|
| # | last_name ′Turing′ |

| | |
|---|---|
| # | } |

b) explicit specified branch ′Names′
name Name {

names { ′Martin′ }

}
#implicit content:
#

| | |
|---|---|
| # | name Name { |

| | | |
|---|---|---|
| # | names | { ′Martin′ } |

| | |
|---|---|
| # | last_name ′Turing′ |

| | |
|---|---|
| # | } |

### EXAMPLE 11

Declaration of standard data types with and without value ranges restrictions. The value range restriction starts with the character SVR=“(” and terminated with the character TVR=“)”.

# ′Bit′ is an arbitrary binary value (either 0 or 1)

| | | |
|---|---|---|
| Bit0 | Bit ′0′ | # bit with default value 0 |
| Boolean | Bit0 | # i.e. 0 = false, 1 = true |
| Byte | Bit[8] | # arbitrary 8-bit binary value |
| Byte0 | Bit0[8] | # Byte with default value 0 |
| Word | Bit[16] | # arbitrary 16-bit binary value |
| Word0 | Bit0[16] | # Word with default value 0 |
| DoubleWord | Word[2] | # arbitrary binary value of 2 Words |
| DoubleWord0 | Word0[2] | # Word with default value 0 |
| QuadWord | Word[4] | # arbitrary binary value of 4 Words |
| Integer | Byte[] | # array of an arbitrary number of bytes |
| Integer0 | Byte0[] | # integer with default value 0 |
| Char | Byte0 | # one byte characters with default value 0 |
| String | Char[] | # array of Char's of unknown length |

Examples of letters with restricted value range

| | |
|---|---|
| Letter | Char (′A′-′Z′, ′a′-z′) |
| CapitalLetter | Char (′A′-′Z′) |
| SmallLetter | Char (′a′-′z′) |
| Digit | Char (′0′-′9′) |
| DigitAndSpace | Char (′0′-′9′, ′ ′) |
| HexDigit | Char (′0′-′9′, ′A′-′F′, ′a′-′f′) |
| Space | Char (′ ′, ′\t′, ′\n′, ′\r′) |
| OnlySpace | Char (′ ′) |
| Punctuation | Char (′.′, ′, ′, ′; ′, ′: ′, ′?′, ′!′) |
| SpecialChar | Char (′\\′, ′/′, ′\′′, ′§′, ′$′, ′%′, ′&′, ′=′, ′ |
| | *′, ′+′, ′−′, ′_′, ′#′) |
| Parenthesis | Char (′(′, ′)′) |
| Brackets | Char (′{′, ′}′) |
| Squares | Char (′[′, ′]′) |

# multiple characters without value range restriction

| | |
|---|---|
| IP4-Address | Byte0 [4] |
| IP6-Address | Byte0 [6] |

# multiple characters with value range restrictions

| | |
|---|---|
| HexByte | HexDigit [2] |
| HexWord | HexDigit [4] |

Composite types with value range restrictions

# string representation of an integer with n characters
IntegerAsString[n] {

| DigitAndSpace [n-1] ′ ′ [n-1] | |
|---|---|
| Digit | ′0′ |

}
# binary representation of a date
Date {

| | | |
|---|---|---|
| month | Byte ′0′ (′0′-′12′) | # - invalid |
| day | Byte ′0′ (′0′-′31′) | # - invalid |
| year | Word ′−1′ | # −1 - invalid |

}
# string representation of a date in US-format mm/dd/yyyy
US-DateAsString {

| | |
|---|---|
| month | DigitAndSpace[2] |
| separator | Char ′/′ (′/′) |
| day | DigitAndSpace [2] |
| separator | Char ′/′ (′/′) |
| year | DigitAndSpace [4] |

}

Methods to describe arbitrary hierarchical data structures according to claims 6 or 7 offer the additional possibility to associate arbitrary attributes to a branch (claim 6) respectively a data element (claim 7). Attribute associations can follow different syntactical rules.

### EXAMPLE 12

Different possible syntax forms to associate the attribute final to a branch with name name.

# attribute, name, content

| | |
|---|---|
| final name { | first_name ′Alan′ |
| | last_name ′Turing′ |

}
# name, attribute, content

| | |
|---|---|
| name final { | first_name ′Alan′ |
| | last_name ′Turing′ |

}
# name, content, attribute

| | |
|---|---|
| name { | first_name ′Alan′ |
| | last_name ′Turing′ |

} final

The interpretation of an attribute—like final—depends on the semantics of the particular language definition. One possible interpretation of the attribute final of a branch B could be, that a sub-branch B1 may not contain more elements than specified in branch B. Another possible interpretation of the attribute final could be, that no further type may be derived from a type with the final attribute. Similar attributes like abstract, protected, private, known to be applicable to methods and member variables in object oriented programming languages like C/C++ or Java, can also be taken over and applied to EDL-branches and data elements.

Attributes can also be named and be assigned attribute values. The specification can follow a simple assignment syntax like

attribute_name=attribut_value

as long as and attribute value contain no empty space. Otherwise, the attribute value has to be introduced with a leading attribute value start character SAV and closed by a attribute value termination character TAV, like in the example

attribute_name=‘attribut value’.

### EXAMPLE 13

Different possible syntax forms to associate the attributes access=rw and color=blue to a data element with name name, type String and content Alan:

# name, type, attribute, content
name String access=rw ′Alan′
# type, name, attribute, content
String name access=rw ′Alan′
# type, attribute, name, content
String access=rw name ′Alan′
# type, name, content, attribute
String name ′Alan′ access=rw
# name, type, attribute, content
name String access=rw color=blue ′Alan′

### EXAMPLE 14

With meta characters

attribute list start SAL=“[”, attribute list end TAL=“]” and

attribute value start SAV=“‘”, attribute value end TAV=“‘”

name String [access = rw color = blue] ′Alan′
name String [access = ′rw′ color = ′blue′] ′Alan′
name [access = rw color = blue] String ′Alan′
name [access = ′rw′ color = ′blue yellow′] String ′Alan′
[access = rw color = blue] name String ′Alan′
name String ′Alan′ [access = rw color = blue]
String name [access = rw color = blue] ′Alan′
String [access = rw color = blue] name ′Alan′
String name ′Alan′ [access = rw color = blue]
[access = rw color = blue] String name ′Alan′

Of cause, other sequences of element name, type, attributes and content than given in the previous examples are also possible. The type can also be specified in the syntactical form of an attribute, i.e. with an attribute named type, but this format requires more meta characters than the direct type specification.

### EXAMPLE 15

name type=String access=rw ‘Alan’

name [type=String access=rw color=blue] ‘Alan’

Individual attributes can be specified at different locations of the element description, whereby multiple attributes can also be positioned at different locations:

### EXAMPLE 16

name String access=rw ‘Alan’ color=blue

[type=String] name [access=rw] ‘Alan’ [color=blue]

Nevertheless, to simplify the parser and to speed up the parsing it is advantageous to fix the sequence of components of a data element description in the syntax of the underlying grammar, like:

<data element description>=<name><type><attributes><content>

### EXAMPLE 17

name String [access=rw color=blue] ‘Alan’

Claim 6 allows also to assign attributes to a whole branch, so that Example 13 can be applied to branches accordingly. Again, it is advantageous to fix the sequence of components of a branch description in the syntax of the underlying grammar, like:

<branch description>=<name><type><attributes><content>

### EXAMPLE 18

Name name [access=rw color=blue] {

first_name ′Alan′
last_name ′Turing′

}

Individual attributes can be associated to data elements and sub-branches of any branch:

### EXAMPLE 19

Name name [access=rw color=blue] {

first_name [access=rw] ′Alan′
last_name [access=r] ′Turing′

}

If attributes of the same name are applied on different branch levels, the semantics of the underlying language defines, which of the attributes replaces the other or whether the final attribute results of any function of all specified attributes with the same name (for example that all attributes of the same name are to merged or concatenated to the final attribute). In Example 19 the language semantics could define either that the attribute access of the data element last_name replaces the attribute ‘access=rw’ of the super-branch or that the attribute ‘access=rw’ of the super-branch replaces the attribute access of the data element ‘last_name’. In the former case the data element ‘last_name’ would receive final attribute ‘access=r’ and in the latter the final attribute access=rw.

Type declarations can also contain attributes:

### EXAMPLE 20

Name [access=rw] {

first_name [color=blue] String
last_name [color=black] String

}

which will be inherited by the derived data elements and branches, if no explicit overriding attributes are specified in the data element and branch declaration itself. The elements of the branches name, name1, name2 and name3 are derived from the type definition given in Example 20

### EXAMPLE 21

Name name {

first_name ′Alan′
last_name ′Turing′

}
Name name1 {

first_name [color=red] ′Alan′
last_name ′Turing′

}
Name name2 {

first_name [flavor=salty] ′Alan′
last_name ′Turing′

}
Name name3 [access=w] {

first_name ′Alan′
last_name [access=rw] ′Turing′

}

are associated implicitly with the following attributes:

name [access=rw] {

first_name [color=blue] String ′Alan′
last_name [color=black] String ′Turing′

}
name1 [access=rw] {

first_name [color=red] String ′Alan′
last_name [color=black] String ′Turing′

}
name2 [access=rw] {

first_name [color=blue flavor=salty] String ′Alan′
last_name [color=black] String ′Turing′

}
name3 [access=w] {

first_name [color=blue] ′Alan′
last_name [color=black access=rw] ′Turing′

}

Of cause, other inheritance rules are possible and need to be specified in the semantics of the underlying language definitions.

Without additional means methods to describe arbitrary hierarchical data structures according to claims 1 to 7 suppose, that all data of a given description is contained within a single data block—a continuous memory segment, a file, or a data stream —. Claim 8 explicitly requires this condition.

To avoid further redundance it is advantageous to isolate repetitive data descriptions as described in claims 9 to 13 into separate data blocks and to include only references to those isolated data blocks in EDL-documents. This has the advantage and disadvantage that modifications of referenced elements will affect all EDL-documents including a reference to the modified element. This technique allows—like in C/C++ header files—to administer global declarations and descriptions in a single, central location. Modifications of global declarations and descriptions used in multiple EDL-documents do not have to be repeated in each dependent EDL-document. Of cause, referenced EDL-documents can reference further EDL-documents, whereby the maximum nesting level is unlimited, as long as no circular reference occurs—e.g. a reference to a previous referring EDL-document.

Using EDL-references and EDL-attributes EDL allows not only to describe tree like data structures, but also hierarchical data webs, in which branches and data elements can be linked—on top of the normal hierarchical parent-child relationship—by arbitrary other associations.

EDL-documents can reference other EDL-documents on the branch level, as well as on the data element and data content level. In the following examples references are introduced by a leading reference start character SR=“<” and closed by a trailing reference termination character TR=“>”, like <reference to external data block>.

References referencing to branches or data elements described in the same data block as the reference are directly specified without reference start/termination characters, like

branch1, branch2.data element1, or

branch1. sub-branch3, etc.

References to branches or data elements defined in other data blocks than the data block containing the reference—called external data blocks—are introduced with a reference to the particular data block, in which the referenced element is described, followed by the name of the branch or data element, like

<external data block>.branch2,

<external data block>.branch2.data element3, or

<external data block>.branch2.sub-branch4, etc.

The referenced files may be located at an arbitrary location in any reachable file or directory structure. References specifying the (Internet-)URL of files/documents stored on other computers reachable via any kind of network, like the Internet, can be easily included into EDL-documents. If a parser finds a URL-reference it automatically loads the referenced file from the computer specified in the URL and includes it in the local document.

Of cause, particular language definitions may also use other syntax forms to specify references, which all are covered by this patent.

### EXAMPLE 22

Definition of the base files and types:

# in file SerialNumber.edl
′1134513489710934713084701394750134′
# in Name.edl

| Name { | first_name String |
|---|---|
| | last_name String |

}
# in PersonalFile.edl

| | |
|---|---|
| <Name.edl> | # includes Name.edl |

| PersonalFile { | name | Name |
|---|---|---|
| | profession | String |

}
# in Account.edl

| | |
|---|---|
| <Name.edl> | # includes Name.edl |

| Account { | name | Name |
|---|---|---|
| | balance | String |

}
# in file AlanTuringsFirstName.edl
′Alan′
# in file AlanTuringsLastName.edl
′Turing′

Referenced data content:

# in file AlanTuring.ed1

first_name <AlanTuringsFirstName.ed1>

last_name <AlanTuringsLastName.ed1>

Referenced type definition, branch content and data element content:

# in AlanTuringsPersonalFile.edl

| | |
|---|---|
| <PersonalFile.edl> | # includes PersonalFile.edl |

PersonalFile AlanTuringsPersonalFile {

| | | |
|---|---|---|
| Name name | <AlanTuring.edl> | # loads branch content |

| | # from AlanTuring.edl |
|---|---|
| profession ′mathematician′ | |
| SerialNumber <SerialNumber.edl> | # loads data element content |

# from SerialNumber.edl

}

Referenced sub-branches and data content:
# In AlanTuringsAccount.edl

| <Account.edl> | | # includes Account.edl |
|---|---|---|
| Account AlanTuringsAccount { | | |
| | AlanTuringsPersonalFile.name | # loads branch name from |
| | | # AlanTurings PersonalFile.edl |

| | |
|---|---|
| AlanTuringsPersonalFile.profession | # loads data element |
| | # profession from Alan- |
| | # TuringsPersonalFile.edl |

| | |
|---|---|
| balance | ′$1002,00′ |
| SN | AlanTuringsPersonalFile.SerialNumber |

# includes the content of the data element SerialNumber in
# AlanTuringsPersonalFile.edl

}
Resolved elements:
# resolved AlanTuring.edl
first_name ′Alan′
last_name ′Turing′
# resolved AlanTuringsPersonalFile.edl
PersonalFile AlanTuringsPersonalFile {

name {

first_name ′Alan′
last_name ′Turing′

| } | |
|---|---|
| profession | ′mathematician′ |
| SerialNumber | ′1134513489710934713084701394750134′ |

}
# resolved AlanTuringsAccount.edl
Account AlanTuringsAccount {

name {

first_name ′Alan′
last_name ′Turing′

| } | |
|---|---|
| profession | ′mathematician′ |
| balance | ′$1002,00′ |
| SN | ′1134513489710934713084701394750134′ |

}

A method to describe arbitrary hierarchical data structures according to claim 14 may include boolean or arithmetic expressions to compare and/or combine arbitrary elements of data content as well as control statements to specify at least a single element or element content in dependence of the result of the expression. These control statements can be chosen in analogy to the control statements of object oriented programming languages—like C/C++ or Java—. Typical examples of control statements are directives for conditional compilation, like #ifdef-#else-#endif in C/C++, or program flow control statements, like if-then-else, while-do, do-while, repeat-until, try-catch-final or for-statements. In opposition to a prior art computer program, which specify the time sequence of actions to be performed by a CPU, EDL-expressions and -statements are used only to efficiently describe arbitrary hierarchical data structures in a platform independent format.

Claims 15 and 16 are concerned with parsers and generators of platform independent descriptions of arbitrary hierarchical data structures according to one of the claims 1 to 14. They cover explicitly—but not exclusively—all cases, in which the other representation

1. may be directly processed without any additional data conversion by an arbitrary processing unit—like a computer CPU—, or

2. is an arbitrary prior art human readable representation—like a HTML, XHTML, XML, MathML, or SGML-document—, or

3. an arbitrary compressed format of a representation of prior art, or

4. an arbitrary compressed format of a representation according to one of the claims 1 to 14, or

5. an arbitrary encrypted format of a representation of prior art, or

6. an arbitrary encrypted format of a representation according to one of the claims 1 to 14.

Claims 17 to 20 cover arbitrary systems storing, processing, transmitting or using at least one part of a platform independent description of an arbitrary hierarchical data structure according to one of the claims 1 to 14, where claim 19 covers explicitly—but not exclusively—the cases, in which a client

1. is implemented as standard prior art TCP/IP-client, or

2. is implemented as client according to U.S. utility patent applications Ser. No. 09/558,435 filed on Apr. 25, 2000 and 09/740,925 filed on Dec. 19, 2000

and claim 20 covers explicitly—but not exclusively—the cases, in which a service

1. is implemented as standard prior art TCP/IP-server, or

2. is implemented as service according to U.S. utility patent applications Ser. No. 09/558,435 filed on Apr. 25, 2000 and 09/740,925 filed on Dec. 19, 2000.

### APPENDIX

### Examples of Possible Grammars

The grammars for methods to describe an arbitrary hierarchical data structure in a platform independent format according to one of the claims 1 to 13 described in this appendix are based on the following syntactical rules:

| 1. | alphabet | Standard US-ASCII | |
|---|---|---|---|
| 2. | branch start, end | SB = “{” | TB = “}” |
| 3. | data content start, end | SD = “′” | TD = “′” |
| 4. | attribute list start, end | SA = “[” | TA = “]” |
| 5. | attribute value start, end | SAV = “′” | TAV = “′” |
| 6. | value range start, end | SAR = “(” | TAR = “)” |
| 7. | reference start, end | SR = “<” | TR = “>” |
| 8. | data content coding & | string coded, binary data hexadecimal | |
| | attribute value coding: | coded special characters are initiated by a | |
| | | leading “\”, like | |
| | | \t - for TAB | \\- for \ |
| | | \n - for LF | \′- for ′ |
| | | \r - for CR | \nnn - for ASCII |
| | | | (nnn) |

| | | |
|---|---|---|
| | | \xhh - for hex-coded ASCII (hh) |
| 9. | empty space: | SPACE, TAB, LF, CR outside data |
| | | content or attribute values are being |
| | | replaced by SPACE. They only serve to |
| | | separate the tokens and to structure |
| | | the text for better human readability. |
| 10. | comment: | “#” initiates a comment, |
| | | the “#” and the rest of the line are ignored |

Bold characters in Courier are part of the EDL-document. All other characters only serve to describe the grammar.

We like to emphasize that claims 1 to 14 also allow other possible grammars, which are also covered with this patent.

### Grammar According to Claim 1

<EDL-1>=[<element list>]

<element list>=<element>[<element list>]

<element>=<branch>|<data element>

<branch>={[<element list>]}

<data element>=‘[<data element content>]’|<data element content>

<data element content>=sequence of an arbitrary number of characters from the alphabet; special characters are coded according to 8.

### Grammar According to Claim 3

<EDL-3>=[<element list>]

<element list>=<element>[<element list>]

<element>=<branch>| <data element>

<branch>=[<name>]{[<element list>]}

<data element>=[<name>]‘[<data element content>]’

<name>=<initial name characters>[<name remainder>]

<name remainder>=<name characters>[<name remainder>]

<initial name characters>=<A-Za-z>

<name characters>=<initial name characters>|<0-9>|<_>

<data element content>=sequence of an arbitrary number of characters from the alphabet; special characters are coded according to 8.

### Grammar According to Claim 5

<EDL-5>=[<element list>]

<element list>=<element>[<element list>]

<element>=<element header><element body>

<element header>=[<type name>][<element name>]

<element body>=<branch body>|<data element body>|<type body>

<branch body>={[<element list>]}

<data element body>=‘[<data element content>]’

<type body>=[‘[<default content>]’]

<type name>=<name>

<element name>=<name>

<name>=<initial name characters>[<name remainder>]

<name remainder>=<name characters>[<name remainder>]

<initial name characters>=<A-Za-z>

<name characters>=<initial name characters>|<0-9>|<_>

<default content>=<data element content>

<data element content>=sequence of an arbitrary number of characters from the alphabet; special characters are coded according to 8.

### Grammar According to Claim 7

<EDL-7>=[<element list>]

<element list>=<element>[<element list>]

<element>=<element header><element body>

<element header>=[<type name>][<element name>][<element attribute>]

<element body>=<branch body>|<data element body>|<type body>

<type name>=<name>

<element name>=<name>

<element attribute>=[<attribute list>]

<branch body>={[<element list>]}

<data element body>=‘[<data element content>]’

<type body>=[‘[<default content>]’]

<attribute list>=<attribute>[<attribute list>]

<attribute>=<attribute name>[=<attribute value>]

<attribute value>=<string>|‘<attribute content>’

<attribute name>=<name>

<name>=<string>

<string>=<first string character>[<string remainder>]

<string remainder>=<string character>[<string remainder>]

<first string character>=<A-Za-z>|<_>

<string character>=<first string character>|<0-9>|<_>

<default content>=<content>

<attribute content>=<content>

<data element content>=<content>

<content>=sequence of an arbitrary number of characters from the alphabet; special characters are coded according to 8.

### Grammar According to Claim 13

<EDL-13>=[<element list>]

<element list>=<element>[<element list>]

<element>=<reference>|<element header><element body>

<element header>=[<type name>][<element name>][<element attribute>]

<element body>=<branch body>|<data element body>|<type body>

<type name>=<name>

<element name>=<name>

<element attribute>=<reference>|[<attribute list>]

<branch body>=<reference>|{[<element list>]}

<data element body>=<reference>|‘[<data element content>]’

<type body>=<reference>|[‘[<default content>]’]

<attribute list>=<reference>|<attribute>[<attribute list>]

<attribute>=<reference>|<attribute name>[=<attribute value>]

<attribute value>=<reference>|<string>|‘<attribute content>’

<reference>=<element reference>|<<reference list>>

<reference list>=<single reference>[,<reference list>]

<single reference>=<element reference>|<file name>|<URL>

<element reference>=<element name>.|<element name>.<element name>[.<element reference>]

<attribute name>=<name>

<name>=<string>

<string>=<first string character>[<string remainder>]

<string remainder>=<string character>[<string remainder>]

<first string character>=<A-Za-z>|<_>

<string character>=<first string character>|<0-9>|<_>

<default content>=<content>

<attribute content>=<content>

<data element content>=<content>

<content>=sequence of an arbitrary number of characters from the alphabet; special characters are coded according to 8.

<file name>=valid file name (may contain additional server name)

<URL>=valid Internet-URL

I claim:

1. Method to describe an arbitrary hierarchical data structure with at least one root branch in a platform independent format, where each branch may contain an arbitrary number (inclusive 0) data elements and an arbitrary number (inclusive 0) dependent branches—called subbranches—, whereby
i. the description of at least one branch B starts with a single character SB of a given alphabet A, and
ii. the description of said branch B lists—after the initial starting character SB—in arbitrary order all subbranches and data elements contained in said branch B, and
iii. the description of said branch B is terminated—after listing all data elements and subbranches contained in said branch B—by a single character TB of said alphabet A, and
iv. the description of at least one data element D of said data elements contained in branch B starts with a single character SD of said alphabet A, and
v. the description of said data element D specifies after said initial starting character SD the data contained in said data element D using any platform independent coding, and
vi. the description of said data element D is terminated—after the specification of the data contained in said data element D—by a single terminating character TD of said alphabet A.

2. Method to describe an arbitrary hierarchical data structure in a platform independent format according to claim 1, whereby at least one branch is identified by a name NK, which said name NK consists of an arbitrary sequence of characters, which characters can be chosen out of an arbitrary given alphabet.

3. Method to describe an arbitrary hierarchical data structure in a platform independent format according to one of the previous claims, whereby at least one data element is identified by a name ND, which said name NK consists of an arbitrary sequence of characters, which characters can be chosen out of an arbitrary given alphabet.

4. Method to describe an arbitrary hierarchical data structure in a platform independent format according to one of the previous claims, whereby a branch type BT is associated to at least one branch and said branch type BT is identified by a name NBT, which said name NBT consists of an arbitrary sequence of characters, which characters can be chosen out of an arbitrary given alphabet.

5. Method to describe an arbitrary hierarchical data structure in a platform independent format according to one of the previous claims, whereby a data type DT is associated to least one branch and said data type DT is identified by a name NDT, which said name NDT consists of an arbitrary sequence of characters, which characters can be chosen out of an arbitrary given alphabet.

6. Method to describe an arbitrary hierarchical data structure in a platform independent format according to one of the previous claims, whereby an arbitrary attribute BA can be associated to at least one branch, and where said attribute AB is identified by a name NBA, which said name NBA consists of an arbitrary sequence of characters, which characters can be chosen out of an arbitrary given alphabet, and where said attribute BA can contain any type of content.

7. Method to describe an arbitrary hierarchical data structure in a platform independent format according to one of the previous claims, whereby an arbitrary attribute DA can be associated to at least one data element, and where said attribute DA is identified by a name NDA, which said name NDA consists of an arbitrary sequence of characters, which characters can be chosen out of an arbitrary given alphabet, and where said attribute DA can contain any type of content.

8. Method to describe an arbitrary hierarchical data structure in a platform independent format according to one of the previous claims, whereby the full description of said hierarchical data structure is stored in a single continuous data block.

9. Method to describe an arbitrary hierarchical data structure in a platform independent format according to one of the previous claims, whereby the description of at least a single branch B1 of said hierarchical data structure is stored in at least one separate data block DB1, which data block DB1 specifies at least one part of the data elements and subbranches contained in said branch B1, and the description of said branch B1 within the description of said hierarchical data structure contains at least one reference to said data block DB1.

10. Method to describe an arbitrary hierarchical data structure in a platform independent format according to claim 9, whereby the description of said branch B1 within the description of said hierarchical data structure contains—in addition to said reference to said data block DB1—the description of at least one subbranch SB1 contained in branch B1, where in the case that said subbranch SB1 is described in said data block DB1 as well as in the description of said hierarchical data structure one of the two last mentioned descriptions is taken as the only valid description of branch SB1.

11. Method to describe an arbitrary hierarchical data structure in a platform independent format according one of the claims 9 and 10, whereby the description of said branch B1 within the description of said hierarchical data structure contains—in addition to said reference to said data block DB1—the description of at least one data element DE1 contained in branch B1, where in the case that said branch B1 is described in said data block DB1 as well as in the description of said hierarchical data structure one of the two last mentioned descriptions is taken as the only valid description of data element DE1.

12. Method to describe an arbitrary hierarchical data structure in a platform independent format according to one of the previous claims, whereby at least one part PD1 of the content of at least one data element D1 of said hierarchical data structure is stored in at least one separate data block DB2, and the description of said data element D1 within the description of said hierarchical data structure contains at least one reference to at least the said data block DB2.

13. Method to describe an arbitrary hierarchical data structure in a platform independent format according to claim 12, whereby the description of said data element D1 within the description of said hierarchical data structure contains—in addition to said reference to said data block DB2—the description of at least one part PD2 of the data contained in data element D1, where in the case that PD1 and PD2 overlap one of the data parts PD1 and PD2 is chosen as the only valid description of said overlapping part of PD1 and PD2.

14. Method to describe an arbitrary hierarchical data structure in a platform independent format, whereby said description of said hierarchical data structure contains at least one expression with at least one logical and/or arithmetic operation or at least one comparison as well as at least one control statement to repeatedly or conditionally specify at least one element or at least one element content in dependence of said expression.

15. Parser of a platform independent description of an arbitrary hierarchical data structure according to one of the previous claims, whereby said parser converts said platform independent description of said hierarchical data structure into an arbitrary other representation, where said other representation is especially—but not exclusively—
i. suited to be processed directly by an arbitrary processing unit—like a CPU of a computer—without any additional data conversion, or
ii. an arbitrary human readable representation of prior art—like HTML, XHTML, XML, MathML or SGML—, or
iii. an arbitrary compressed format of a representation of prior art, or
iv. an arbitrary compressed format of a representation according to one of the claims 1 to 14, or
v. an arbitrary encrypted format of a representation of prior art, or
vi. an arbitrary encrypted format of a representation according to one of the claims 1 to 14.

16. Generator of a platform independent description of an arbitrary hierarchical data structure according to one of the previous claims, whereby said generator converts an arbitrary other representation of said hierarchical data structure into a platform independent description of said hierarchical data structure according to one of the claims 1 to 14, where said other representation is especially—but not exclusively—
i. suited to be processed directly by an arbitrary processing unit—like a CPU of a computer—without any additional data conversion, or
ii. an arbitrary human readable prior art representation—like HTML, XHTML, XML, MathML or SGML—, or
iii. an arbitrary compressed format of a representation of prior art, or
iv. an arbitrary compressed format of a representation according to one of the claims 1 to 14, or
v. an arbitrary encrypted format of a representation of prior art, or
vi. an arbitrary encrypted format of a representation according to one of the claims 1 to 14.

17. Arbitrary information processing system, which stores and/or processes at least one part of a platform independent description of an arbitrary hierarchical data structure according to one of the claims 1 to 14 in any format.

18. Arbitrary communication system with at least two communication partners, where at least one of said communication partners sends at least one message in an arbitrary way to the other, whereby said message contains in an arbitrary format at least one part of a platform independent description of an arbitrary hierarchical data structure according to one of the claims 1 to 14 in any format.

19. Arbitrary inter process communication system with at least one arbitrary client and at least one arbitrary service, where said client comprises means to send directly or indirectly requests to said service and to receive directly or indirectly replies from said service, and said service comprises means to receive directly or indirectly requests from said client and to send directly or indirectly replies to said client, whereby said client sends in at least one request at least one part of a platform independent description of an arbitrary hierarchical data structure according to one of the claims 1 to 14 in any format to said service.

20. Arbitrary inter process communication system with at least one arbitrary client and at least one arbitrary service, where said client comprises means to send directly or indirectly requests to said service and to receive directly or indirectly replies from said service, and said service comprises means to receive directly or indirectly requests from said client and to send directly or indirectly replies to said client, whereby said service replies to at least one request from said client with at least one reply containing at least one part of a platform independent description of an arbitrary hierarchical data structure according to one of the claims 1 to 14 in any format to said client.
